(19) United States
(12) Patent Application Publication
(10) Pub. No.: US 2026/0197284 A1
(43) Pub. Date: Jul. 9, 2026

(54) SYSTEM AND METHOD FOR NETWORK WIDE GUARANTEED DELIVERY OF FRAMES

(71) Applicant: Canoga Perkins Corporation, Chatsworth, CA (US)

(72) Inventors: Sameer Bagepalli RAMESH, Bangalore (IN); Narendra PATEL, Gujarat (IN); Brian KEANE, Ventura, CA (US); Rahul KHATRI, Haryana (IN)

(21) Appl. No.: 19/419,531

(22) Filed: Dec. 15, 2025

Related U.S. Application Data
(60) Provisional application No. 63/742,574, filed on Jan. 7, 2025.

(51) Int. Cl. H04L 49/112; H04L 45/24; H04L 47/32; H04L 49/20

(52) U.S. Cl. CPC H04L 49/112; H04L 45/24; H04L 47/32; H04L 49/205

(57) ABSTRACT

A method and system for network level and protocol agnostic frame replication and elimination in a time-sensitive communications network to improve reliability of frame and packet transmission across the time-sensitive communications network. The method includes replication of a plurality of sequential frames delivered to a communications network across a plurality of member streams distributed across a plurality of interconnected switches of the communications network, wherein each frame of the plurality of sequential frames is identifiable via a sequence number and a member stream number inserted into each frame, whereupon receipt of each frame at an egress switch of the communications network, each frame is examined to determine which member stream the frame originated from, where the frame belongs in the plurality of sequential frames, and whether that frame has already been received from another member stream. All duplicate frames are eliminated, and each frame is egressed in sequential order.

### CROSS-REFERENCE TO RELATED APPLICATIONS

Not applicable.

### FIELD OF THE INVENTION

The present invention relates generally to systems and methods to guarantee delivery of frames across multiple devices in a packet transmission network, and in particular, where such systems and methods are independent of specific network layer and protocol requirements.

### BACKGROUND OF THE INVENTION

Real-time network communications needs are increasing across multiple sectors, and as a result, reliability of such communications systems is paramount. Time-Sensitive Networking (TSN) standards have been introduced to ensure that communication across an existing network system has increased reliability. Existing network systems are often unable to tolerate dropped or lost packet transmissions being retransmitted across the network.

Typical packet transmission networks (also referred to as time-sensitive communications networks, communications networks, and networks throughout) comprise a collection of interconnected network devices, such as network switches or routers, each having two or more ports governed by a unified network level set of forwarding rules which determine how packets or frames traverse the network from a source (ingress switch) to a destination (egress switch). A network controller or other network management system oversees each individual network device and utilizes an aggregated network level view of the overall network configuration and performance characteristics.

One standard introduced to improve real-time network communication is IEEE 802.1CB, known as Frame Replication and Elimination for Reliability (FRER), which provides redundant pathways for duplicated packet delivery across the network. This seamless redundancy allows for redundancy in data transmission paths, ensuring that if one path fails, an alternate path can be used to maintain uninterrupted communication. Once one of these duplicated packets or frames is received at the corresponding end node, excess duplicates are eliminated such that only one instance of the data is ultimately delivered. The standard further defines quality of service (QoS) as the overall performance of a packet or frame as it relates to packet loss probability, latency, and latency variation.

Generally, the FRER standard replicates and divides an initial data stream into one or more linked member streams, defining a compound stream made up of the member streams. The compound stream exists between the ingress switch and the egress switch after replication and prior to elimination of duplicate frames. Each member stream is generally directed across diverse pathways through the network to offer redundancy while minimizing overlapping pathways to reduce the risk of delays, dropped frames, or other failures of the pathway caused by a shared network device or port from impacting multiple member streams.

A sequence number is inserted into each frame at the ingress switch prior to it being replicated and delivered on each of the member streams to the egress switch. As each frame of each of the member streams is received at the designated egress switch, the egress switch, as configured by the network controller, evaluates the sequence number associated with the frame to identify duplicate frames. The sequence number is compared to a sequence history variable which maintains an updated list of received sequence numbers for recently received frames. Only frames received within a specific timing window are compared, and sequence numbers of those that are received within the timing window are checked against the list of received sequence numbers. If no matching sequence number is found in the list of received sequence numbers, the frame is determined to be a new frame. If a matching sequence number is found in the list of received sequence numbers, the frame is discarded. New frames are delivered out the egress port and its sequence number is recorded onto the list of received sequence numbers. The list of received sequence numbers may be reset upon the timing window elapsing without receiving a frame having a new sequence number. In this manner, the FRER standard attempts to eliminate duplicate frames, while accounting for networking scenarios that result in dropped frames of the particular member stream.

However, FRER has several limitations that must be addressed. First, typical implementations of FRER are network layer or protocol specific, resulting in a lack of flexibility to operate across different packet transmission networks or virtual local area network (VLAN) layers. Furthermore, neither the FRER standard nor any existing solutions in the industry have provided an effective technique to allocate a specific predetermined quality of service to a customer as it relates to packet loss probability, latency, and latency variation. For example, no existing frame replication and elimination paradigms provide monitoring and feedback to identify latency on specific network pathways relative to other network pathways to be addressed.

### BRIEF SUMMARY OF THE INVENTION

In one aspect the present invention is a system implementing a frame replication and elimination method independent of existing network configurations, protocols, or standards. The present invention replicates frames received from a source stream along an existing packet transmission network comprising a plurality of interconnected network switches (switches) from an ingress port on an initial switch (ingress switch) to an egress port on a terminal switch (egress switch) regardless of network layer or protocol. The replicated frames are distributed through unique subject pathways through the packet transmission network defining a compound stream of replicated frames, wherein each pathway defines a member stream of the compound stream. A predetermined QoS is allocated to a customer by the creation of a virtual circuit controlled by a network controller, wherein the frames traverse through a chain of custody between each network switch of the packet transmission network. The network controller configures each network switch to perform the functions of the frame replication and elimination method of the present invention, including identifying, replicating, and marking frames, as described elsewhere herein. The predetermined QoS sets a packet loss probability, latency, and latency variation tolerance for the virtual circuit. At each switch in the packet transmission network, the switch, as configured by the network controller, then identifies each frame entering the switch to determine the disposition of the frame, as well as how the frame should be forwarded through the network relative to a forwarding table associated with each switch. If the forwarding table indicates that the frame is to be replicated, for each frame in the sequence, a common sequence number is inserted into each of the replicated frames. Additionally, a unique member number is inserted into each frame, wherein the unique member number identifies the frame as belonging to a specific member stream of the compound stream. Each replicated frame is then directed to an egress port of the switch, each egress port associated with one or more of the member streams. If the forwarding table indicates that the frame is to be transmitted without replication, the frame is forwarded to an associated egress port of the switch. Finally, if the forwarding table indicates that the frame is to processed for elimination, a compound stream number will be inserted into the frame, at which point the frame will be transmitted to a destination egress port portion of the switch to determine whether the frame will be eliminated or egressed.

In another aspect the present invention is a method of replicating and eliminating frames between an ingress port on an ingress switch to an egress port on an egress switch of a packet transmission network independent of network layer or protocol, the packet transmission network governed by a network controller. The network controller configures each network switch of the packet transmission network to execute a replication and elimination algorithm for each frame of a plurality of sequential frames transiting the packet transmission network, the algorithm comprising examining a frame from a source stream at an ingress switch of the packet transmission network, inserting a sequence number into each frame corresponding to a position of the frame in the plurality of sequential frames, replicating the frame for travel across a plurality of member streams when an entry point bit is enabled on a forwarding table of the ingress switch, wherein each member stream together defines a compound stream, forwarding each replicated frame to an associated egress port of the ingress switch, each egress port associated with one or more member streams of the plurality of member streams, inserting a member stream number into each frame, the member stream number identifying the member stream the replicated frame is associated with, egressing each replicated frame to a subsequent switch along the associated member stream, transmitting each frame from each intermediary switch along the plurality of member streams, wherein a transit bit is enabled on the forwarding table of each intermediary switch, receiving each frame at an egress switch of the packet transmission network, inserting a compound stream number into each frame, identifying frames having undiscovered sequence numbers, queuing the undiscovered sequence numbers until all sequence numbers have been discovered, egressing a resultant stream, the resultant stream comprising the plurality of sequential frames in order of sequence number from the egress switch.

The above and other aspects of the invention are set forth in this specification and the appended claims.

### BRIEF DESCRIPTION OF THE DRAWINGS

The appended drawings, as briefly summarized below, are provided for exemplary understanding of the invention, and do not limit the invention as further set forth in this specification:

FIG. 1 is a simplified diagram representative of a network implementing the frame replication and elimination method of the present invention.

FIG. 2(a) is a diagram illustrating the forwarding table of an ingress switch set to replicate a source stream of the present invention.

FIG. 2(b) is a diagram illustrating the forwarding table of a transit switch set to forward each replicated frame to a destination switch of the present invention.

FIG. 2(c) is a diagram illustrating the forwarding table of an egress switch set to identify and eliminate duplicate frames from the result stream of the present invention.

FIG. 2(d) is a diagram illustrating a sequence number tracking table used to process each frame at the egress switch of the present invention.

FIG. 2(e) is a diagram illustrating the member sequence number tracking table used to process each frame at the egress switch of the present invention.

FIG. 3 is a flow diagram illustrating the process steps for the method for network wide guaranteed delivery of frames of the present invention.

FIG. 4 is a diagram illustrating egress switch frame processing and management system for each compound stream of the present invention.

FIG. 5(a) is a state diagram illustrating an enqueuing control process for each sequence number of each compound stream of the present invention.

FIG. 5(b) is a state diagram illustrating a dequeuing control process for each sequence number of each compound stream of the present invention.

FIG. 5(c) is a diagram illustrating a timing window relative to a series of sequence numbers of a discrete sequence of frames of each compound stream.

FIG. 6 is a flow diagram illustrating the frame processing logic at the egress switch of the present invention.

### DETAILED DESCRIPTION OF THE INVENTION

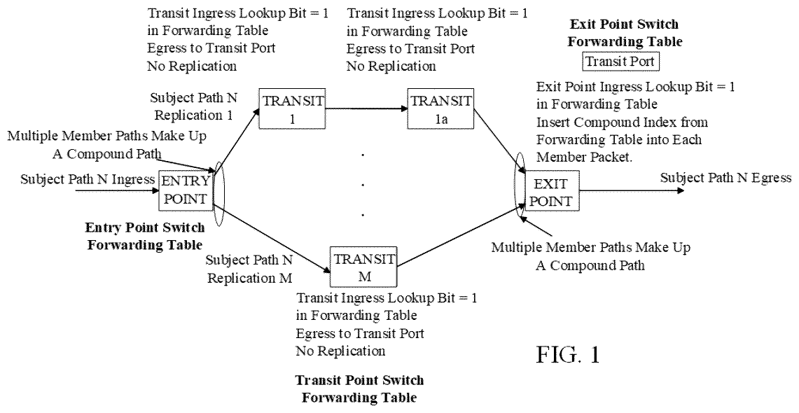

In the illustrated embodiment of FIG. 1, there is shown a generic communications network comprising a plurality of network switches, wherein each switch of the plurality of network switches comprises two or more ports, wherein the two or more ports comprise at least one ingress port and at least one egress port. The number of ports on each switch can vary across the network. One or more virtual circuits are defined within the communications network and run therethrough, the one or more virtual circuits enabling conformance to the specifications of each customer. Each component of the virtual circuit is configured to allocate resources such that the specifications of the customer are met. For example, customer specifications may necessitate a specific degree of required frame replication to ensure reliable delivery of those frames, such that the virtual circuit includes all frames identified by the customer to require that reliability of delivery. In the shown example, the switches are connected in a generic mesh topology, however the various other network topologies are compatible with the system and method of the present invention.

The communications network is governed by a network controller (not shown) which manages each individual network switch of the plurality of network switches with an aggregated view of the performance of the communications network, and wherein the network controller implements the replication and elimination method described herein. In a preferred embodiment, the network controller reprograms field programmable gate arrays (FPGAs) disposed on each network switch of the plurality of network switches to facilitate implementation of the replication and elimination method of the present invention as further described herein. In this manner, the communications network is flexible and programmable to accommodate changes in network parameters, the number of virtual circuits, and external system connections without replacing individual network switches reliant on onboard silicon or otherwise governed by hardware limitations. The invention requires network knowledge at a higher level with data path evaluation on throughput and network burden for deterministic available frame delay variations. Such information regarding the available data paths and frame delay variations across the established communications network may be determined by typical network pathing methodologies, such as, but not limited to spanning tree analysis, however for the purposes of this disclosure, the communications network is considered to be fully mapped and evaluated prior to the implementation of the method of the present invention. This knowledge is imparted into each device involved in the replication and elimination network.

Generally, the present invention provides redundant data paths (frame transmission pathways) for resilient communication from an ingress point into the network (an initial ingress port of an initial switch of the network) through an egress point of the network (a terminal egress port of a terminal switch of the network) using forwarding tables in each of the devices involved in the communications network. In an exemplary embodiment, a plurality of sequential frames enters the network ingress point at the initial switch (ingress switch) via a source stream. The source stream comprises multiple distinct pluralities of sequential frames representative of discrete ordered sequences of information, such that the method of the present invention is applied separately with respect to all such discrete ordered sequences of information present in the source stream. The forwarding tables may further be set up to identify which distinct pluralities of sequential frames of the source stream comprise a part of the virtual circuit. In this manner, only those streams designated to be replicated, and therefore those streams that are part of the virtual circuit, are subject to the method of the present invention. The plurality of sequential frames is then replicated and sent along two or more defined frame transmission pathways through the network to a terminal switch (egress switch). These replicated frames distributed along distinct frame transmission pathways are also referred to as member streams, wherein the member streams in aggregate comprise a compound stream representing M replications of the plurality of sequential frames delivered to the ingress switch via the source stream. As one or more of the plurality of sequential frames are received at the egress switch, additional duplicates of each frame of the plurality of sequential frames received are eliminated according to an elimination methodology further described elsewhere herein. As each compound stream represents a singular plurality of sequential frames, multiple compound streams may be delivered across the communications network simultaneously and across shared or distinct frame transmission pathways, such that the method of the present invention is implemented for each compound stream.

FIG. 1 illustrates an exemplary communications network having a plurality of network switches disposed in a mesh topology. The communications network comprises a plurality of frame transmission pathways (member streams) defined between an egress port of an ingress switch and an ingress port of an egress switch, each frame transmission pathway passing through one or more intermediary switches, wherein the plurality of frame transmission pathways is predetermined and monitored by the network controller. The plurality of frame transmission pathways is substantially independent, such that transmission of frames across the communications network minimizes use of the same network resources to transmit replicated data streams. In the shown embodiment, a source stream comprising a plurality of sequential frames (indicated as N total frames in FIG. 1) enters the ingress switch (Entry Point switch) and exits through an egress switch (Exit Point switch) after passing through one or more intermediary switches (Transit switch 1, Transit switch 1a, Transit switch M).

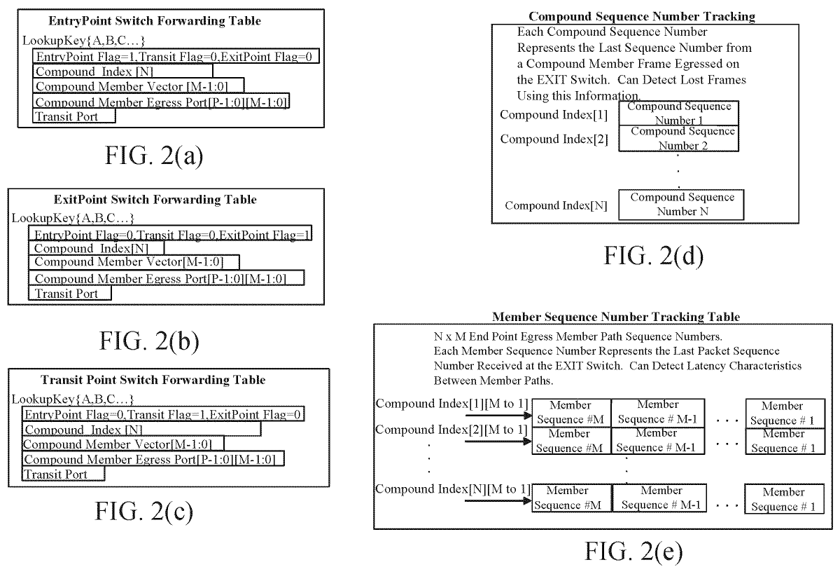

Frame transmission along the time-sensitive communications network is governed by a forwarding table associated with each switch, wherein each forwarding table is configured to direct each frame to the next switch disposed along each pathway of the plurality of frame transmission pathways. The replication disposition of the frame is further determined by information in the forwarding tables. As illustrated in FIG. 2(a), FIG. 2(b), and FIG. 2(c), the forwarding tables each include Entry Point, Transit, and Exit Point flag entries identifying which switch serves as the ingress switch, intermediary switch, and egress switch along the communications network. For example, if the Entry Point flag entry is set in the forwarding table, as shown in FIG. 2(a), then this indicates that the associated switch is the ingress switch, and therefore the ingress switch is to replicate the frame and deliver the replicated frames to the predetermined egress ports of the ingress switch, wherein each egress port of the ingress switch is associated with one or more distinct frame transmission pathways across the time-sensitive communications network. Alternatively, if the Transit flag is set, as illustrated in FIG. 2(c), then the associated switch, identified as a transit or intermediary switch for the compound stream, will pass the frame to the designated egress port associated with the member stream of the received frame. Finally, if the Exit Point flag is set, as shown in FIG. 2(b), then the associated switch, identified as an egress switch for the particular compound stream, will insert a compound index (compound stream number) into the frame prior to delivering the frame to the designated egress port of the egress switch. The compound index indicates the decision logic for selecting which frames of the compound stream will be egressed in a resultant compound stream and which frames are duplicates that must be eliminated as further described elsewhere herein. In one embodiment, the forwarding tables may comprise hybrid forwarding tables, where two identifying flags are set, such that combination Entry Point/Transit switches and Transit/Exit Point switches may be present. For example, some frames sent to the same switch having both the Entry Point flag set and the Transit flag set selected may be replicated and transmitted to distinct egress ports of the switch, further branching the frame transmission pathways, while alternate already replicated frames may be transmitted to the egress ports without additional replication.

As shown in FIG. 2(d), a compound sequence number tracking table is illustrated, wherein the compound sequence number (from a first compound sequence number 1 to a last compound sequence number N) represents a frame having the last sequence number from one of M member streams egressed from the egress switch. As such, the sequence number tracking table may be applied to each member stream to individually track which frames have been received and egressed from the egress switch on a member stream basis. The compound sequence number tracking table operates as an index of compound streams processed through the packet transmission network. The index to the sequence number tracking table is contained in each frame received by the egress switch as it is processed for egress. The compound sequence number of the sequence number tracking table is updated with the sequence number of the frame to be egressed whenever a frame from the compound sequence is egressed from the egress switch. By monitoring the egressed frames from each member stream, and the associated values of the sequence number tracking table, lost frames can be detected. In this manner, lost frames across all member streams can be accounted for and substituted with a frame from a different member stream having an equivalent sequence number.

As illustrated in FIG. 2(e), there is shown a member sequence number tracking table, wherein the member sequence number tracking table comprises a compound stream number sequence, as those tracked by the compound sequence number tracking table of FIG. 2(d), for each member stream, resulting in N compound streams across M member streams for a total of N×M table entries. Each member sequence number represents the last frame sequence number received at the egress switch. The member sequence number tracking table defines an index comprising a combination of the compound stream index and the member stream index parsed by the frame received at the egress switch. The values of the member sequence numbers can then be compared within the compound stream to determine latency differences between members of a compound stream. By monitoring and cataloguing the sequence numbers of all received frames across all member streams, relative latency between the member streams can be tracked in real time. In this manner, predicted arrival times of frames having a specific sequence number may be estimated to inform a timing window to ensure a complete sequence of frames can be assembled in the correct order prior to egressing the plurality of sequential frames from the egress switch. In one embodiment, the member sequence number tracking table may be utilized to calibrate a timing window Y as further described elsewhere herein prior to a live application of the present invention, for example in a training mode. In such embodiments, test frames of varying frame lengths may be processed by the present system to identify and optimize an ideal timing window for a particular use case, such that the timing window captures a desired number of frames.

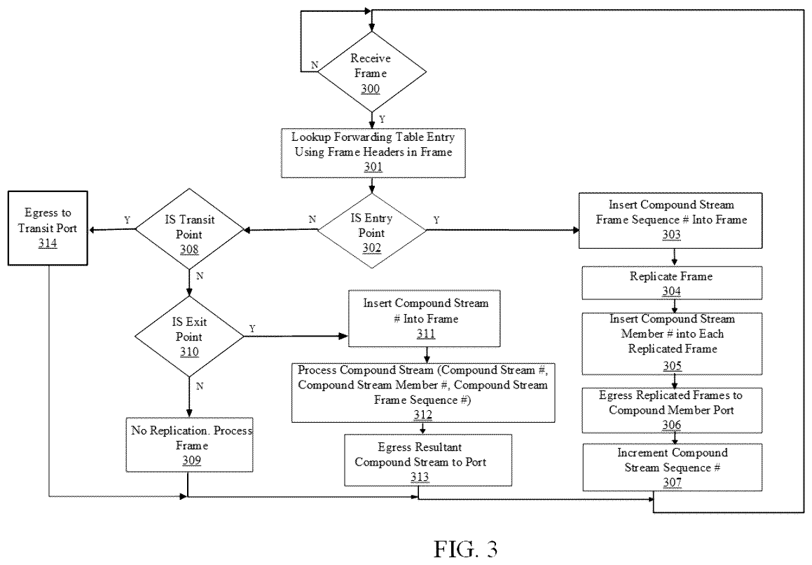

Referring now to FIG. 3, there is shown a flow chart of the process steps for the method of network wide guaranteed delivery of frames of the present invention. Beginning at step 300, once a frame of the plurality of sequential frames is received at each switch of the communications network, headers of the frame are compared to the forwarding table of the switch to ascertain the disposition of the frame at step 301, i.e., whether the frame is to be replicated across a plurality of member streams. At step 302, if the switch is identified as an ingress switch, wherein the forwarding table includes an enabled Entry Point flag, the compound stream sequence number is inserted into the frame at step 303. The frame is then replicated at step 304 into a desired number of copies corresponding to the number of member streams designated across the communications network. At step 305, a compound stream member number is then inserted into each replicated frame, wherein the compound stream member number identifies the particular member stream each replicated frame is associated with. Each of the replicated frames are then egressed at step 306 from the ingress switch via an egress port corresponding to the member stream associated with each replicated frame. The compound stream sequence number is then incremented at step 307 for the next frame in the plurality of sequential frames.

If at step 302 the switch is not identified as an ingress switch, the process continues by identifying whether the switch is an intermediary switch at step 308. If the switch is identified as an intermediary switch, wherein the forwarding table includes an enabled Transit flag, the frame is not subjected to additional modification or replication and is instead directed to the egress port of the switch corresponding to the member stream associated with the frame at step 314. The frame is then egressed to the next switch in the frame transmission pathway.

If at step 308 the switch is not identified as an intermediary switch, the process continues by identifying whether the switch is an egress switch at step 310. If the switch is not identified as an egress switch, the frame is processed normally with no replication at step 309. If the switch is identified as an egress switch, wherein the forwarding table includes an enabled Exit Point flag, the compound stream number is inserted into the frame at step 311. The frame is then delivered to the egress port of the egress switch whereupon the frame is processed by the egress switch, as configured by the network controller, relative to all frames transiting in the compound stream at step 312. The frame is processed in a manner to eliminate duplicate frames that have already been received at the egress switch, such that a single copy of each frame of the plurality of sequential frames is retained and assembled in sequential order as further described elsewhere herein. The frame is then egressed from the egress switch in sequential order relative to the plurality of sequential frames, forming a resultant compound stream at step 313.

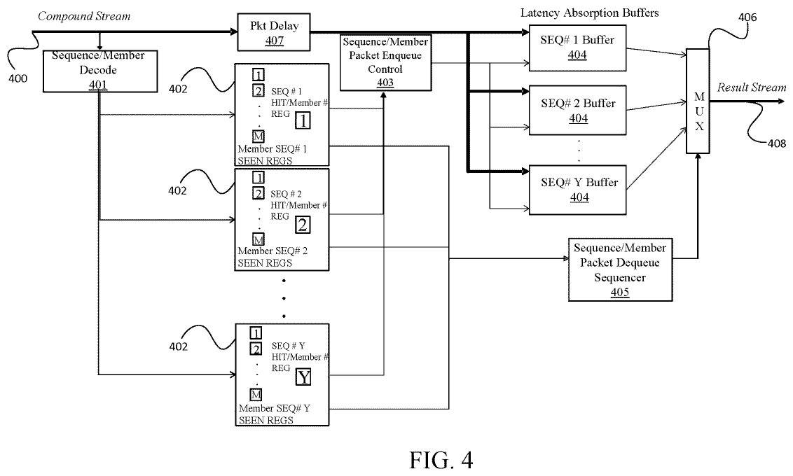

FIG. 4 illustrates the egress switch frame processing and management system for each compound stream of the present invention. It should be understood that the processing methodology shown in FIG. 4 occurs for each compound stream representing distinct pluralities of sequential frames replicated across multiple member streams present in the communications network. As shown, each compound stream 400 is sampled through a decoding controller 401 and presented to a plurality of sequence tracking stages 402, wherein each sequence tracking stage 402 corresponds to a particular compound stream sequence number previously inserted into each frame of the plurality of sequential frames. The sequence tracking stages represent a total sequence number space from 0 to N. The compound stream 400 is then sent through a packet delay element 407, wherein the packet delay element 407 is configured to mimic the frame processing delay experienced in the egress frame processing step, such that when the frame exits the packet delay element 407, the egress frame processing step is completed to ensure that instruction timing as a result of the below egress frame processing step is synchronized with the frame present in the compound stream 400. In other words, the packet delay element 407 ensures that instructions determined as a result of the egress frame processing step are applied to the correct, corresponding frame in the compound stream 400.

The decoding controller 401 presents frames from each member stream to the sequence tracking stage 402 corresponding to the compound stream sequence number of each frame, wherein the sequence tracking stage 402 identifies and registers (SEEN registers, member number register) which member stream each frame having the same compound stream sequence number originated from. Generally, each earliest arriving frame of each compound stream sequence number is stored in one or more latency absorption buffers 404 by an enqueueing controller 403. The purpose of the latency absorption buffer 404 is to prevent delivery of out of order frames from the plurality of sequential frames due to varying arrival times across all member streams. In the shown embodiment, a latency absorption buffer 404 is provided for each sequence number present in the sampled compound stream 400 expected to arrive within a specific timing window Y representing a number of frames expected to arrive at the egress switch at any given moment as further described elsewhere herein. Once the earliest arriving frame of each compound stream sequence number is registered by the sequence tracking stage 402 and stored in the associated latency absorption buffer 404, all future frames having the same compound stream sequence number from the remaining member streams are eliminated. As each sequence number is stored in the latency absorption buffer 404, a dequeuing control 405 egresses each frame if the sequence number of the frame is the next sequence number in the sequence. Once the subsequent frame is egressed, the latency absorption buffer 404 and sequence tracking stage 402 associated with the recently egressed frame are incremented to receive sequence numbers after the timing window Y on a rolling basis. For example, once a frame having a sequence number of 1 (SEQ #1 Frame) is egressed by the dequeuing control 405, the sequence tracking stage 402 and latency absorption buffer 404 associated with SEQ #1 increment to identify and store SEQ #Y+1 frames, respectively. This repeats in a circular manner until the total number of sequence numbers have been associated with each sequence tracking stage 402 and each latency absorption buffer 404, thereby representing an entire sequence of frames being egressed in sequential order.

By way of example, a first member stream may deliver a frame having a sequence number of 2 (SEQ #2 Frame) without delivering a frame with a sequence number of 1 (SEQ #1 Frame). The SEQ #2 Frame is then stored in an appropriate latency absorption buffer 404 until a SEQ #1 Frame arrives to prevent out of order deliveries. All member streams processed through the present system would then eliminate any SEQ #2 Frames regardless of which member stream the frame is associated with. Once a SEQ #1 Frame arrives and is stored in an associated latency absorption buffer 404, the SEQ #1 Frame is egressed, followed by the SEQ #2 Frame. The associated sequence tracking stages 402 and latency absorption buffers 404 then increment to capture frames at an end of the limited window of frames Y. Specifically, the SEQ #1 sequence tracking stage 402 and latency absorption buffer 404 become a SEQ #Y+1 and the SEQ #2 sequence tracking stage 402 and latency absorption buffer 404 become SEQ #Y+2. This repeats for all sequence numbers until the timing window encapsulates the final sequence number in the sequence of frames (SEQ #N). Therefore, as each sequence number has been registered and identified, a dequeuing controller 405 egresses each frame of the plurality of sequential frames in order from SEQ #1 to SEQ #N, as illustrated through a multiplexor 406, to create a resultant stream 408 containing the plurality of sequential frames. In this manner, duplicate sequence numbers and out of order sequence numbers are avoided.

As the egressing processing and management system analyzes each frame received across each member stream, the egressing processing and management system may further identify a relative delay in receiving frames having the same sequence number from each of the member streams. This delay can be used to identify latency discrepancies between each of the member streams, highlighting member streams with bottlenecks, overtaxed resources, or other network traffic issues responsible for the delays in real time. In some embodiments, the network controller receives this latency information as feedback to determine frame transmission pathways for future compound streams accounting for current network traffic limitations.

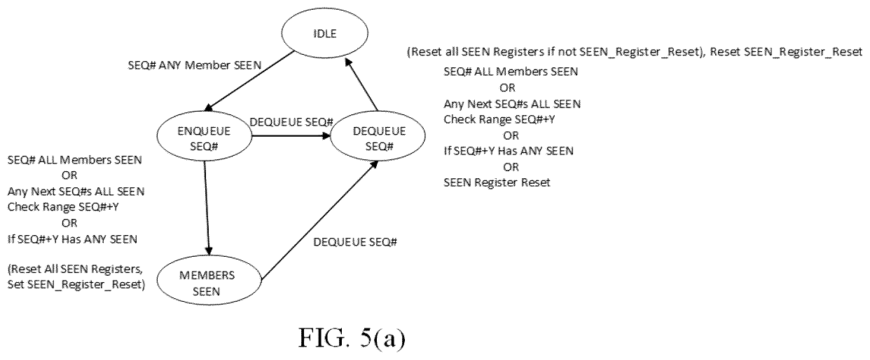

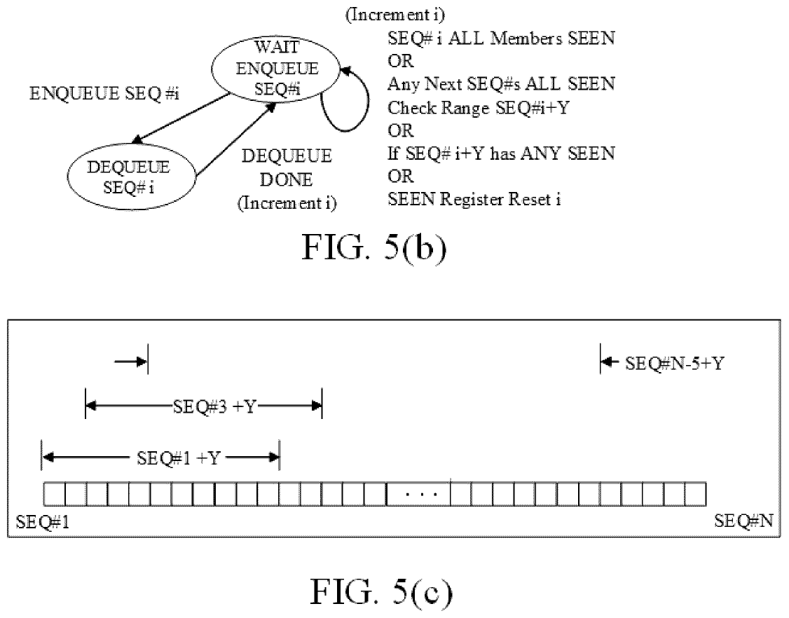

As illustrated in FIG. 5(a), the enqueueing controller logic is illustrated for each compound stream sequence number. The enqueuing controller defines a timing window Y representative of the number of frames present in the communications network, as further illustrated in FIG. 5(c). The timing window Y can further be illustrated as a window of sequence numbers that may be expected to arrive at the egress switch at any moment as a result of being within the parameters of multipath latency expectations of the packet transmission network. As each frame with the sequence number is determined to be received, the timing window Y shifts by one sequence number while maintaining an equivalent range. For example, once a frame with sequence number 0 (SEQ #0 Frame) is received, the sequence number space shifts to encompass a range of sequence numbers from 1 to Y+1. The timing window Y rolls continuously across the total number of sequence numbers X, such that once the timing window exceeds the final sequence number (SEQ #X Frame), the timing window wraps around to encompass a SEQ #0 Frame of a subsequent plurality of sequential frames. This timing window Y is referred to for a determination of likelihood of any outstanding frames arriving, effectively determining a reset criterion for the SEEN registers monitored by the enqueueing controller. As shown, the enqueuing controller may check the range of sequence numbers outside the timing window past the latest registered sequence number to determine whether the frame having an outstanding sequence number is lagging sufficiently to presume that the frame has been dropped. In the shown embodiment, an alternate reset criteria comprises if the enqueuing controller has seen a frame with a subsequent sequence number for each of the member streams, for example, if the SEQ #1 Frame is outstanding and the SEQ #2 Frame has been identified for all M member streams, then it can be determined that the SEQ #1 Frame has been dropped and will not arrive.

As each sequence number is seen for the plurality of sequential frames, the dequeuing controller initiates a dequeuing process, whereupon each registered frame stored in the latency absorption buffer is egressed through the egress port of the egress switch in consecutive order. The dequeuing controller initially egresses an initial frame (SEQ #1 Frame) and then increments the sequence number and egresses each frame until a final frame of the plurality of sequential frames (SEQ #X Frame) is egressed. The dequeuing controller monitors the timing window Y and the SEEN registers to determine whether to continue to the subsequent sequence number. Each of the latency absorption buffers includes a “first in, first out” (FIFO) descriptor which holds each sequence number of the frames in the associated latency absorption buffer. As the dequeuing controller searches for a next sequence number to dequeue, the sequence number is compared to the sequence number in the latency absorption buffer FIFO descriptors, whereupon a matching latency absorption buffer FIFO descriptor identifies which latency absorption buffer is to egress the frame.

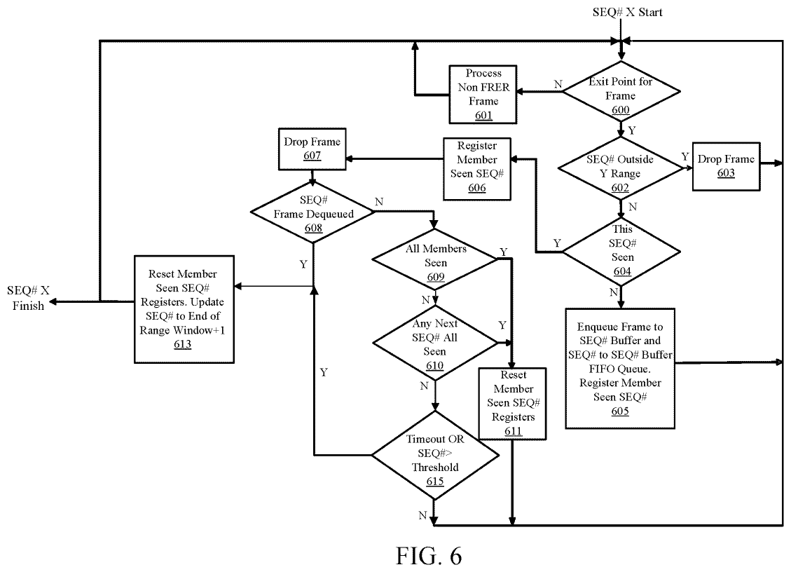

Referring now to FIG. 6, a flow chart is illustrated demonstrating frame processing at the egress switch. Beginning at step 600, as each frame arrives at the egress switch, each frame is queried to determine whether the egress switch is designated as an egress switch for this particular frame. If the frame is not egressing at this switch, or if the frame has not been subject to replication per the present invention, then the frame is processed and egressed from the egress switch at a desired egress port at step 601. Once the frame is verified to be a replicated frame destined for egress at the instant egress switch, the frame is examined to determine whether the compound stream sequence number is outside of the designated range of the timing window Y at step 602. If the frame is outside of the timing window Y, the frame is dropped at step 603. If the frame is within the range of the timing window Y, the compound stream sequence number is compared to all compound stream sequence numbers stored in SEEN register (sequence number register) to determine whether the same frame has already arrived at the egress switch via a different member stream at step 604. If the frame comprises a compound stream sequence number not presently stored in the SEEN register, then the frame is enqueued to the latency absorption buffers and ordered with already stored frames according to the latency absorption buffer FIFO queue at step 605. Also at step 605, the compound stream member number is further registered with a member SEEN register, wherein the member stream the frame belongs to is catalogued to identify that the subject member stream has delivered a frame having the compound stream sequence number. If the compound stream sequence number is already registered at step 604, then the compound stream member number is registered to the member SEEN register at step 606 and the frame is dropped at step 607. At step 608, the system queries whether the frame associated with the compound stream sequence number has already been dequeued. If the frame has not been dequeued, the system queries the member SEEN register to determine whether the compound stream sequence number across all member streams has been seen at step 609. If all member streams have been seen, then the member SEEN register is reset at step 611. If the compound stream sequence number is not registered for all member streams, then the system queries whether any single next compound stream sequence numbers have been registered in the SEEN register across all member streams (i.e., if SEQ #1 Frame is being processed, the system determines whether the SEQ #2 Frame has been seen across all member streams) at step 610. If all next compound stream sequence numbers have been seen, then the member SEEN register is reset at step 611. If no next compound stream sequence numbers have been registered across all member streams at step 610, then the system determines whether a timeout has occurred, or whether the compound stream sequence number exceeds a defined threshold at step 615. If the system determines that the criteria is satisfied at either of steps 608 or 615, then the member SEEN registers are reset at step 613. Also at step 613, the timing window Y shifts as previously described above.

Reference throughout this specification to “one example or embodiment,” “an example or embodiment,” “one or more examples or embodiments,” or “different example or embodiments,” for example, means that a particular feature may be included in the practice of the invention. In the description various features are sometimes grouped together in a single example, embodiment, figure, or description thereof for the purpose of streamlining the disclosure and aiding in the understanding of various inventive aspects.

The present invention has been described in terms of preferred examples and embodiments. Equivalents, alternatives and modifications, aside from those expressly stated, are possible and within the scope of the invention. Those skilled in the art, having the benefit of the teachings of this specification, may make modifications thereto without departing from the scope of the invention.

1. A system for guaranteed delivery of frames across a packet transmission network, the system comprising:
a packet transmission network comprising a plurality of network switches, the plurality of network switches interconnected to define a plurality of frame transmission pathways therebetween;
a plurality of virtual circuits, each virtual circuit defined between two endpoints of the packet transmission network and configured to transmit one or more sets of sequential frames between the two endpoints, wherein each set of sequential frames comprises an initial frame, one or more subsequent frames, and a final frame;
wherein each virtual circuit of the plurality of virtual circuits is created by a network controller to conform to one or more predetermined maximum allowable quality of service requirements;
wherein the network controller configures each network switch of the plurality of network switches to execute a frame replication and elimination process for each virtual circuit corresponding to an enabled identification flag on a forwarding table of each network switch to meet at least one of the one or more predetermined maximum allowable quality of service requirements;
wherein the frame replication and elimination process is not performed on each virtual circuit that lacks the enabled identification flag;
wherein the frame replication and elimination process comprises, for each of the one or more sets of sequential frames, the steps of:
receiving a frame of an instant set of sequential frames at an instant network switch of the plurality of network switches;
querying the forwarding table of the instant network switch for the enabled identification flag associated with an instant virtual circuit, wherein the enabled identification flag comprises one of: an entry point flag identifying the instant network switch as a replication ingress switch, an exit point flag identifying the instant network switch as a replication egress switch, and a transit flag identifying the instant network switch as a replication intermediary switch;
wherein if the enabled identification flag is the entry point flag, the instant network switch of the plurality of network switches executes the following steps:
inserting a compound stream sequence number into the frame, wherein the compound stream sequence number identifies a position of the frame within the instant set of sequential frames;
replicating the frame a number of times equivalent to a quantity of member streams sufficient to meet the one or more predetermined quality of service requirements, defining a plurality of replicated frames, wherein each member stream corresponds to a set of contiguous frame transmission pathways disposed between the replication ingress switch and the replication egress switch;
wherein each member stream together defines a compound stream;
inserting a compound stream member number into each replicated frame of the plurality of replicated frames, wherein the compound stream member number identifies the member stream each replicated frame is associated with;
egressing each replicated frame through an egress port of the instant network switch associated with the corresponding member stream;
incrementing the compound stream sequence number for a subsequent frame of the instant set of sequential frames;
wherein if the enabled identification flag is the transit flag, the instant network switch of the plurality of network switches executes the following steps:
querying the frame for the compound stream member number inserted therein;
egressing the frame through an egress port of the instant network switch associated with the member stream corresponding to the compound stream member number;
wherein if the identification flag is the exit point flag, the instant switch of the plurality of network switches executes the following steps:
inserting a compound stream number into the frame, wherein the compound stream number comprises an index indicating decision logic for selecting which replicated frames of the plurality of replicated frames are to be eliminated;
processing each replicated frame from each member stream according to a compound stream processing algorithm to enqueue a first arriving replicated frame across each of the member streams and eliminate all duplicate frames arriving from one or more different member streams;
egressing the first arriving replicated frame of the instant set of sequential frames from an egress port of the instant network switch once the compound stream processing algorithm identifies that the first arriving replicated frame is next in the sequence of the instant set of sequential frames;
repeating each step of the frame replication and elimination process for each subsequent frame of the instant set of sequential frames until the final frame of the instant set of sequential frames is egressed from the replication egress switch.

2. The system of claim 1, wherein the network controller programs one or more field-programmable gate arrays disposed on each network switch of the plurality of network switches to define the one or more virtual circuits in real time.

3. The system of claim 1, wherein the network controller further configures each network switch of the plurality of network switches to direct each member stream of the plurality of member streams across independent frame transmission pathways of the plurality of frame transmission pathways, such that no two member streams of the plurality of member streams share a frame transmission pathway.

4. The system of claim 1, wherein the enabled identification flag comprises a combination of the entry point flag and the transit flag defining an entry point hybrid switch or a combination of the exit point flag and the transit flag defining an exit point hybrid switch, wherein a subset of frames are treated as though only the entry point flag or the exit point flag, respectively, was enabled and a remainder of the frames are treated as though only the transit flag was enabled.

5. The system of claim 1, wherein the compound stream processing algorithm comprises, for each compound stream sequence number, the steps of:
sampling each replicated frame from the compound stream to produce a sampled frame for evaluation;
presenting the sampled frame to a sequence tracking stage disposed on the instant network switch, the sequence tracking stage corresponding to the compound stream sequence number of the sampled frame;
comparing the compound stream sequence number of the sampled frame to a sequence number register disposed on the instant network switch;
enqueuing the replicated frame corresponding to the sampled frame from the compound stream in a latency absorption buffer associated with the associated compound stream sequence number if the compound stream sequence number is not present on the sequence number register;
adding the compound stream sequence number to a latency buffer FIFO queue;
ordering the compound stream sequence numbers in the latency buffer FIFO queue in sequential order;
registering the compound stream sequence number to the sequence number register if the compound stream sequence number is not present on the sequence number register;
registering the compound member stream number of the replicated frame corresponding to the sampled frame to a member number register disposed on the instant network switch;
eliminating the replicated frame corresponding to the sampled frame if the sequence number register includes the compound stream sequence number associated with the frame;
dequeuing the replicated frame from the latency absorption buffer when the associated compound stream sequence number is next in a sequence of the set of sequential frames; and
resetting the member number register.

6. : The system of claim 5, wherein the compound stream processing algorithm further comprises the steps of:
determining whether the compound stream sequence number is outside of a timing window prior to comparing the compound stream sequence number to the sequence number register, wherein the timing window comprises a constant range representing a subset of compound stream sequence numbers of the instant set of sequential frames;
dropping the replicated frame if the compound stream sequence number is outside of the timing window; and
incrementing the timing window after resetting the member number register to exclude the compound stream sequence number of the replicated frame dequeued from the latency absorption buffer.

7. The system of claim 5, wherein the compound stream processing algorithm further comprises the steps of:
delaying the replicated frame present in the compound stream via a packet delay element after the replicated frame has been sampled;
releasing the replicated frame from the packet delay element after the compound stream sequence number is compared to the sequence number register.

8. The system of claim 5, wherein the compound stream processing algorithm further comprises the steps of:
recording an arrival time of each replicated frame having the same compound stream sequence number across each of the plurality of member streams;
determining a relative arrival time delay of each replicated frame having the same compound stream sequence number between each member stream of the plurality of member streams;
comparing the relative arrival time delay of each member stream to expected latency values for each member stream to identify latency discrepancies between each member stream.

9. The system of claim 5, wherein the compound stream processing algorithm further comprises resetting the member number register prior to dequeuing the replicated frame upon determining that each compound stream member number has been registered for a subsequent compound stream sequence number.

10. The system of claim 6, wherein the compound stream processing algorithm further comprises resetting the member number register prior to dequeuing the replicated frame upon determining that the compound stream sequence number of the replicated frame exceeds a defined threshold.

11. The system of claim 1, wherein the one or more predetermined maximum allowable quality of service requirements are selected from a group consisting of: a maximum allowable frame loss probability, a maximum allowable latency, and a maximum allowable latency variation tolerance.

12. A method for guaranteeing delivery of one or more sets of sequential frames, each comprising an initial frame, one or more subsequent frames, and a final frame from an ingress switch of a packet transmission network to an egress switch of the packet transmission network and conforming to one or more predetermined maximum allowable quality of service requirements, the packet transmission network comprising a plurality of interconnected network switches governed by a network controller, the network controller configured to program each network switch of the plurality of interconnected network switches to implement the method comprising the steps of:
receiving a frame of an instant set of sequential frames at an instant network switch of the plurality of network switches;
querying the forwarding table of the instant network switch for the enabled identification flag associated with an instant virtual circuit, wherein the enabled identification flag comprises one of: an entry point flag identifying the instant network switch as a replication ingress switch, an exit point flag identifying the instant network switch as a replication egress switch, and a transit flag identifying the instant network switch as a replication intermediary switch;
wherein if the enabled identification flag is the entry point flag, the instant network switch executes the following steps:
inserting a compound stream sequence number into the frame, wherein the compound stream sequence number identifies a position of the frame within the instant set of sequential frames;
replicating the frame a number of times equivalent to a quantity of member streams sufficient to meet the one or more predetermined quality of service requirements, defining a plurality of replicated frames, wherein each member stream corresponds to a set of contiguous frame transmission pathways disposed between the replication ingress switch and the replication egress switch;
wherein each member stream together defines a compound stream;
inserting a compound stream member number into each replicated frame of the plurality of replicated frames, wherein the compound stream member number identifies the member stream each replicated frame is associated with;
egressing each replicated frame through an egress port of the instant network switch associated with the corresponding member stream;
incrementing the compound stream sequence number for a subsequent frame of the instant set of sequential frames;
wherein if the enabled identification flag is the transit flag, the instant network switch executes the following steps:
querying the frame for the compound stream member number inserted therein;
egressing the frame through an egress port of the instant network switch associated with the member stream corresponding to the compound stream member number;
wherein if the identification flag is the exit point flag, the instant network switch executes the following steps:
inserting a compound stream number into the frame, wherein the compound stream number comprises an index indicating decision logic for selecting which replicated frames of the plurality of replicated frames are to be eliminated;
processing each replicated frame from each member stream according to a compound stream processing algorithm to enqueue a first arriving replicated frame across each of the member streams and eliminate all duplicate frames arriving from one or more different member streams;
egressing the first arriving replicated frame of the instant set of sequential frames from an egress port of the instant network switch once the compound stream processing algorithm identifies that the first arriving replicated frame is next in the sequence of the instant set of sequential frames;
repeating each step of the frame replication and elimination process for each subsequent frame of the instant set of sequential frames until the final frame of the instant set of sequential frames is egressed from the replication egress switch.

13. The method of claim 12, wherein the network controller programs one or more field-programmable gate arrays disposed on each network switch of the plurality of network switches to define the one or more virtual circuits in real time.

14. The method of claim 12, wherein the network controller further configures each network switch of the plurality of network switches to direct each member stream of the plurality of member streams across independent frame transmission pathways of the plurality of frame transmission pathways, such that no two member streams of the plurality of member streams share a frame transmission pathway.

15. The method of claim 12, wherein the compound stream processing algorithm comprises, for each compound stream sequence number, the steps of:
sampling each replicated frame from the compound stream to produce a sampled frame for evaluation;
presenting the sampled frame to a sequence tracking stage disposed on the instant network switch, the sequence tracking stage corresponding to the compound stream sequence number of the sampled frame;
comparing the compound stream sequence number of the sampled frame to a sequence number register disposed on the instant network switch;
enqueuing the replicated frame corresponding to the sampled frame from the compound stream in a latency absorption buffer associated with the associated compound stream sequence number if the compound stream sequence number is not present on the sequence number register;
adding the compound stream sequence number to a latency buffer FIFO queue;
ordering the compound stream sequence numbers in the latency buffer FIFO queue in sequential order;
registering the compound stream sequence number to the sequence number register if the compound stream sequence number is not present on the sequence number register;
registering the compound member stream number of the replicated frame corresponding to the sampled frame to a member number register disposed on the instant network switch;
eliminating the replicated frame corresponding to the sampled frame if the sequence number register includes the compound stream sequence number associated with the frame;
dequeuing the replicated frame from the latency absorption buffer when the associated compound stream sequence number is next in a sequence of the set of sequential frames; and
resetting the member number register.

16. The method of claim 15, wherein the compound stream processing algorithm further comprises the steps of:
determining whether the compound stream sequence number is outside of a timing window prior to comparing the compound stream sequence number to the sequence number register, wherein the timing window comprises a constant range representing a subset of compound stream sequence numbers of the instant set of sequential frames;
dropping the replicated frame if the compound stream sequence number is outside of the timing window; and
incrementing the timing window after resetting the member number register to exclude the compound stream sequence number of the replicated frame dequeued from the latency absorption buffer.

17. The method of claim 15, wherein the compound stream processing algorithm further comprises the steps of:
delaying the replicated frame present in the compound stream via a packet delay element after the replicated frame has been sampled;
releasing the replicated frame from the packet delay element after the compound stream sequence number is compared to the sequence number register.

18. The method of claim 15, wherein the compound stream processing algorithm further comprises the steps of:
recording an arrival time of each replicated frame having the same compound stream sequence number across each of the plurality of member streams;
determining a relative arrival time delay of each replicated frame having the same compound stream sequence number between each member stream of the plurality of member streams;
comparing the relative arrival time delay of each member stream to expected latency values for each member stream to identify latency discrepancies between each member stream.

19. The method of claim 15, wherein the compound stream processing algorithm further comprises resetting the member number register prior to dequeuing the replicated frame upon determining that each compound stream member number has been registered for a subsequent compound stream sequence number.

20. The method of claim 15, wherein the compound stream processing algorithm further comprises resetting the member number register prior to dequeuing the replicated frame upon determining that the compound stream sequence number of the replicated frame exceeds a defined threshold.
